(19) United States
(12) Patent Application Publication
(10) Pub. No.: US 2010/0231184 A1
(43) Pub. Date: Sep. 16, 2010

(54) Step up and down switching power converter's output current detect and control scheme

(76) Inventors: Qi Cui Wei, Sunnyvale, CA (US); Da Feng Weng, (US)

Correspondence Address: Qi Cui Wei, 972 Ponderosa Ave, Apt#C, Sunnyvale, CA, 94086, US

(21) Appl. No.: 12/583,576

(22) Filed: Aug. 24, 2009

(30) Foreign Application Priority Data
Mar. 12, 2009 (CN) 200910096641.0

(51) Int. Cl. H02M 3/04

(52) U.S. Cl. 323/282

(57) ABSTRACT

The invention presents a simple and high accuracy output current detect and control scheme to control the output current of the step up-down (Buck-Boost) and step up (Boost) switching converter, It makes step up-down (Buck-Boost) and step up (Boost) switching power converter operate in wide input voltage range and low in total BOM cost and the switching converter can be used as a controllable current source for several applications

### BACKGROUND OF THE INVENTION

The present invention relates to step up-down (Buck-Boost) and step up (Boost) switching power converter's output current detect and control scheme. More particularly, the invention relates to a simple and high accuracy output current detect and control scheme to control the output current of the step up-down (Buck-Boost) and step up (Boost) switching converter, and the switching converter can be used as a controllable current source for several applications.

In practical DC-DC power converter switching converter application, as the input voltage of the switching converter has wide range variation, that is, the input voltage is lower and higher than the output voltage of the switching converter; step up-down (buck-boost) switching converter is the first choice. No matter what is the input voltage, the output of the step up-down (Buck-Boost) switching converter can be in what is required, voltage or current.

In DC-DC voltage power switching converter application, it is easy to detect the input and output voltages of the step up-down (Buck-Boost) switching converter. Detected input and output voltages can be used to regulate in the system closed loop to control the output voltage in high accuracy. The output voltage can be independent of the variation of input voltage and the load.

In DC-DC current power switching converter application, e.g. HB LED driving and battery charging application, the output current of DC-DC current power switching converter needs high accuracy control. In order to control the output current in high accuracy, the output current requires to be detected and in this way. The detected output current can be used to regulate in the system closed loop to control the output current in high accuracy. The output current can be independent of the variation of input voltage and the load. The DC-DC current power switching converter can be effectively used in HB LED driving and battery charges application.

In practical HB LED driving and battery charging application, as the input voltage has wide range variation, that is, the input voltage is lower and higher than the output voltage of the switching converter; step up-down (buck-boost) switching converter is the first choice. To detect the output current of the step up-down (buck-boost) switching converter, the existed output current detecting method is to use a detecting resistor to series with the load and the voltage drop on the detecting resistor has linear relation with the output current. But the voltage drop on the detecting resistor has common mode voltage, that is, the input voltage. To detect the voltage drop on the detecting resistor, it needs extra current amplifier and level shift function to take off the common mode voltage, that is, the input voltage, and output the detected output current signal. The detected output current can be used to regulate in the system closed loop to control the output current in high accuracy. The extra current amplifier and level shift function is limited with common mode voltage range, that is, the input operating voltage range. The cost for the extra current amplifier and level shift function is high and it makes the step up-down power current converter in high cost, especially, in wide input operating voltage range.

### SUMMARY OF THE INVENTION

The present invention discloses a novel “step up-down (Buck-Boost) and step up (Boost) switching power converter's output current detect and control scheme” scheme to detect and control the output current of step up-down (Buck-Boost) and step up (Boost) switching power current converter and without limitation on the input operation voltage range issue.

The control scheme of “step up-down (Buck-Boost) and step up (Boost) switching power converter's output current detect and control scheme” is composed of several blocks: The reference block, to generates preset control signal; output variable detecting block, to detect the output variable of switching power converter; output variable signal process block, to process the detected output variable signal and convert it into the same signal format as one of output from reference block; The error generator and amplifier, to detect the error between the outputs from reference block and detected process block, and amplify the error, and compensate the error; inductor current loop regulator, to regulate the inductor current of step up-down (Buck-Boost) and step up (Boost) switching power converter.

Output variable detecting block is used to detect the output capacitor's current of step up-down (Buck-Boost) and step up (Boost) switching power converter.

Output variable detecting block can be composed of a resistor or several operating function block.

Output variable process block is related with the power switch turn-on signal of step up-down (Buck-Boost) and step up (Boost) switching power converter.

Output variable process block is composed of a simple sample-holder or several operating function block.

Inductor current loop regulator can be one of existed current mode control schemes.

The output of the inductor current loop regulator can also be used in the output variable process block.

The present invention can be used in step up (Boost) switching power converter.

In order to compare the reference current with the average output current during the power switch turn-on, the output of the output variable detecting block is processed in the output variable process block. In error detector and amplifier, the error between the output of the output variable process block and the output of the reference block is detected, amplified and compensated. The output of the error detector and amplifier is used as a control signal for the current loop regulator. The output of the current loop regulator controls the power switch turn on and off, and it makes the inductor current of step up-down (Buck-Boost) and step up (Boost) switching power converter to follow the control signal. The output of the current loop regulator is also used as a control input for output variable process block.

The present invention is simple in structure, easy in implement. It can save the extra current amplifier and level shift function block and it makes step up-down (Buck-Boost) and step up (Boost) switching power converter without limitation on input operating voltage range. It makes step up-down (Buck-Boost) and step up (Boost) switching power converter operate in wide input voltage range and low in total BOM cost.

### BRIEF DESCRIPTION OF THE DRAWINGS

FIG. 1 is an existed output current detecting and control scheme for step up-down (Buck-Boost) switching power converter.

FIG. 2 is the present invention block diagram of output current detecting and control scheme for step up-down (Buck-Boost) switching power converter.

FIG. 3 is one detailed embodiment of invention scheme block diagram for step up-down (Buck-Boost) switching power converter.

FIG. 4 is one detailed embodiment of invention scheme block diagram for step up (Boost) switching power converter.

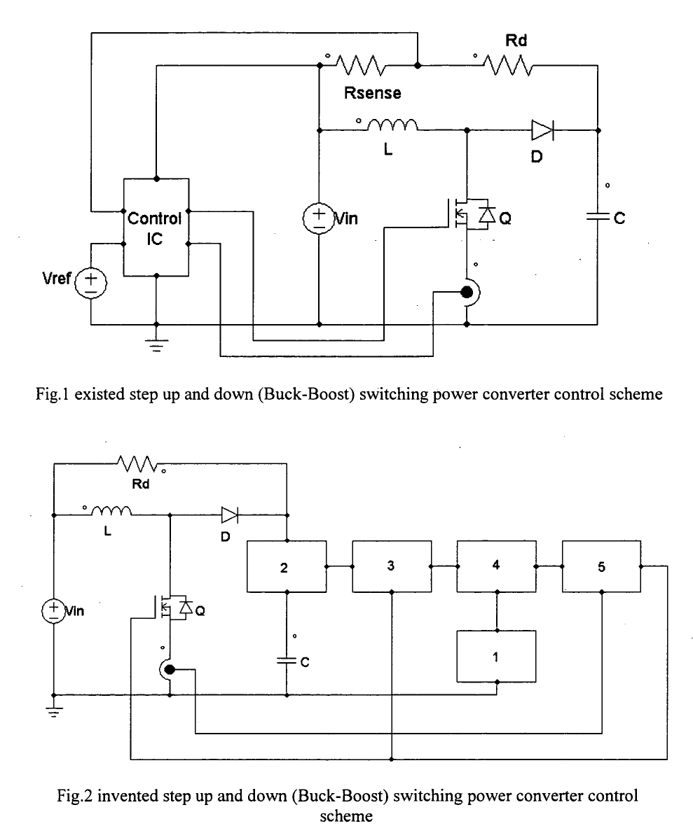

In figures, 1 is for reference block, 2 is for output variable detect block, 3 is for output variable process block, 4 is for error amplifier and compensation, 5 is for current loop regulator block, Rsense is a detecting resistor, Rd is a load.

### DETAIL DESCRIPTION OF THE INVENTION

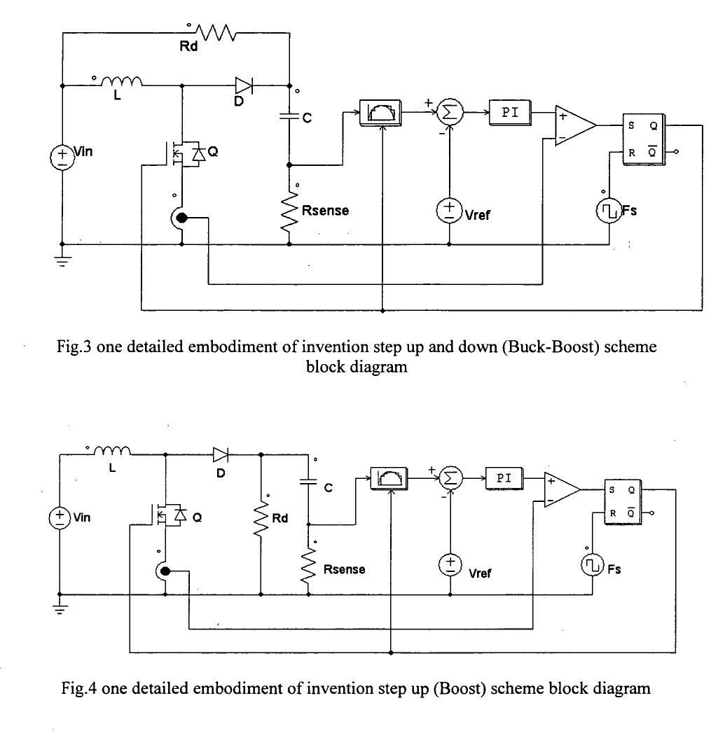

Detailed embodiment 1 of invention: Step up-down (Buck-Boost) switching power converter control scheme block diagram is shown in FIG. 3. In steady state operation condition, the control scheme operating principle is: as the power switch Q turns on, the inductor L stores the energy from the input voltage and the output capacitor offers the output current to the load Rd. As the power switch turns off, the inductor L releases the stored energy. Both the input voltage and the inductor L offer energy to the load and the output capacitor C to compensate the lost energy during the power switch turn-on. Based on the operating principle, it is known that as the power switch turns on, the current in the output capacitor is the load current; and as the power switch turns off, the current in the output capacitor is the difference of the inductor current and the output load current. The output capacitor is used to store energy and filter the ripple of the output ripple current. The capacitor value is higher and makes the ripple of the output current lower. For one switching period, the output current can be considered as a constant. The current in the output capacitor can be detected through a series resistor. The voltage drop on the series resistor is reflected with the current in the output capacitor.

As the power switch Q turns on, the current in the output capacitor is sample-hold (through output variable process block). The output from the sample-hold (output variable process block) is the detected output current signal. As shown in FIG. 3, the series resistor can be inserted between the output capacitor and ground. The voltage drop on the series resistor is only the output current signal and the common mode voltage is zero during power switch Q turn-on. It is zero common mode voltage that doesn't need an extra level shift function block. The gain of sample-hold can be used for detected current signal amplifier. The detected output current is compared with the reference signal (from reference block) in close loop regulation to generate error signal. The error signal is amplified and compensated to be as control signal for the inductor current loop regulator block. The output of current loop regulator controls the power switch turn-on and off of step up-down power converter and make the output current follow the reference signal in high accuracy.

The inductor current loop regulation can be one of existed control schemes, e.g. peak current mode control, average current mode control.

The present invention can be used in step up power converter. The system can operate in wide input voltage range and in low cost. Due to no detecting component in the load loop, it is very easy to make multi-modules common ground driving.

Detailed embodiment 2 of invention: As shown in FIG. 4, the present invention can be used in step up power converter.

The present invention can be used in both step up-down (Buck-Boost) and step up (Boost) power converter.

What is claimed is:

1. Step up-down (Buck-Boost) switching power converter's output current detect and control scheme comprising:
Reference block to generates preset control signal; and
Output variable detecting block to detect the, output variable of switching power converter; and
Output variable signal process block to process the detected output variable signal and convert it into the same signal format as one of output from reference block; and
Error generator and amplifier detect the error between the outputs from reference block and detected process block, and amplify the error, and compensate the error; and
Inductor current loop regulator regulates the inductor current of step up-down (Buck-Boost) switching power converter.

2. Step up-down (Buck-Boost) switching power converter's output current detect and control scheme claim 1, wherein output variable detecting block is used to detect the output capacitor's current of step up-down (Buck-Boost) and step up (Boost) switching power converter.

3. Step up-down (Buck-Boost) switching power converter's output current detect and control scheme claim 1, wherein output variable detecting block can be composed of a resistor or several operating function block.

4. Step up-down (Buck-Boost) switching power converter's output current detect and control scheme claim 1, wherein output variable process block is related with the power switch turn-on signal of step up-down (Buck-Boost) switching power converter.

5. Step up-down (Buck-Boost) switching power converter's output current detect and control scheme claim 1, wherein output variable process block is composed of a simple sample-holder or several operating function block.

6. Step up-down (Buck-Boost) switching power converter's output current detect and control scheme claim 1, wherein inductor current loop regulator can be one of existed current mode control schemes.

7. Step up-down (Buck-Boost) switching power converter's output current detect and control scheme claim 1, wherein the output of the inductor current loop regulator can also be used in the output variable process block.

8. Step up-down (Buck-Boost) switching power converter's output current detect and control scheme claim 1, wherein the present invention scheme can be used in step up (Boost) power converter.
